(19) United States
(12) Patent Application Publication
(10) Pub. No.: US 2008/0199577 A1
(43) Pub. Date: Aug. 21, 2008

(54) Consumer food storage package with absorbent food pad

(75) Inventors: Ronald Jensen, Chicago, IL (US); Sayandro Versteylen, Ontario, CA (US)

Correspondence Address: Charles N.J. Ruggiero;Ohlandt, Greeley, Ruggiero & Perle, L.L.P., One Landmark Square, 10th Floor, Stamford, CT, 06901-2682, US

(73) Assignee: PAPER-PAK INDUSTRIES

(21) Appl. No.: 11/807,138

(22) Filed: May 25, 2007

Related U.S. Application Data
(60) Provisional application No. 60/890,968, filed on Feb. 21, 2007.

(51) Int. Cl. B65B 55/00; B32B 3/02; B65D 81/26

(52) U.S. Cl. 426/393; 206/204; 426/398; 428/68; 428/76

(57) ABSTRACT

The present disclosure is directed to a consumer food storage package to preserve the freshness of food, having an absorbent food pad positioned within a food storage container. The container or absorbent food pad can have a securing means, so that the pad can be positioned in place in the food storage container. Also disclosed is a method for using the food storage package to preserve the freshness of food.

### CROSS-REFERENCE TO RELATED APPLICATIONS

The present application is claiming priority of U.S. Provisional Patent Application Ser. No. 60/890,968, filed on Feb. 21, 2007, the content of which is herein incorporated by reference.

### BACKGROUND OF THE INVENTION

1. Field of Invention

The present disclosure relates to a consumer food storage package that has a food storage container and a disposable absorbent food pad to preserve the freshness of food. The pad may be held in place within the container by a securing means. The present disclosure also discloses a method of using the consumer food storage package.

2. Description of the Related Art

Absorbent food pads are used in the retail food packaging industry to absorb moisture and fluids exuded from meat, poultry, seafood, and produce, thereby improving the safety, shelf life, and aesthetics of the packaged food. Many foods contain appreciable amounts of moisture as well as fluids capable of transporting bacteria or other microorganisms, which can reduce shelf life and quality of the packaged food.

Absorbent food pads have been used in certain types of food packages to soak up excess moisture and fluids exuded from food, and provide a safer, more appealing product to place on the grocery store shelf or cooler for sale to the public.

A typical food package is a thin foam tray or pallet, on which an absorbent food pad is placed. The food is placed on top of the absorbent food pad, and then the tray, pad, and food are overwrapped with a piece of thin, clear plastic film that is stretched over the open top of the tray in order to completely enclose the food. The plastic film is sealed to the tray by brief application of heat to the edges of the piece of plastic film. The typical food package provides a convenient, self-contained package so that a consumer can pick up and inspect the food package without directly contacting the food.

However, the typical food package described above is for a single use only. When the consumer wishes to remove the food from the package, the stretchable plastic film overwrap is removed or cut away from the tray so that the food can be removed. After part or all of the food is removed from the tray, the plastic film overwrap is discarded, and usually the tray and the absorbent food pad are discarded as well. If a consumer desires to place some portion of the food back in the refrigerator or freezer for storage, the portion of food may be re-wrapped in freezer wrap or placed inside a sealable flexible plastic bag, and then placed in the refrigeration unit. However, when the food is taken out later and thawed, the wrap or bag is often soaked with water and fluids from the food because there was no absorbent food pad placed with the portion of food that was re-wrapped.

For convenience and economy, grocery stores often package multiple servings of food in a single package. When a consumer returns home from the grocery store or meat store, the consumer removes the meat or produce from the store packaging, and repackages the food into more convenient portions. For example, a consumer may buy a food package from the store containing three (3) pounds of ground sirloin. When the consumer brings the food package home, the ground sirloin may be divided into three (3) separate one-pound portions, placing one pound in the refrigerator to be cooked later that day, and re-packaging the other two one-pound packages in freezer wrap, in flexible plastic freezer bags, or inside plastic containers (such as TUPPERWARE™-type containers), which are then placed in the refrigeration unit.

Consumers bringing meat or produce home from the store to redistribute and repackage into more-convenient serving sizes rarely transfer the expended absorbent food pad from the grocery package into separate containers being used at home for refrigeration or freezing. The expended absorbent food pad may be saturated with moisture and fluids exuded from the food product and, if the pad contained any active agents to improve freshness, the active agents in the absorbent food pad may already be “used up.” In addition, meat and produce purchased at the counter of a meat store or butcher shop often is simply wrapped in paper without an absorbent food pad that could be transferred into a consumer food storage container.

Consequently, when consumers bring home meat and produce from the store and repackage the meat and produce in new packages having more convenient serving portions, such re-packaged foods no longer contain an absorbent pad to absorb large amounts of moisture and fluids from the food, inhibit microbial growth, or modify the atmosphere contained within the re-packaging. The result is that food that is re-packaged by consumers often loses its freshness or appeal before the consumer is ready to cook or eat the food. This leads to consumers discarding food before use, wasting food and money.

As a means to increase the freshness and appearance of food for sale in retail settings, some food packaging contains a packet (or sachet) with an active agent inside that generates gases that prolong most measures of freshness (or, conversely, that scavenges gases that are deleterious to freshness). The active agents, typically carbon dioxide generators, oxygen scavengers and ethylene scavengers, are usually contained inside a packet or sachet that is placed inside the container in such a way as to minimize contact with food. Such packets or sachets, however, are configured to protect their contents and to generate or scavenge as much of the desired gas as possible, and do not absorb large amounts of fluids and excess moisture exuded from meats and produce.

Thus a need exists for a consumer food storage package containing an absorbent consumer food pad capable of absorbing large amounts of water and other fluids exuded from foods, such as meats and produce, after the consumer re-packages the food into more-convenient serving sizes within consumer containers. There also is a need for a consumer absorbent food pad that can be secured within the consumer food storage container. There is a need for such an absorbent consumer pad that contains antimicrobial agents and/or atmosphere modifying systems to prolong freshness of food when used in a consumer's container.

### SUMMARY OF THE INVENTION

The present disclosure provides a consumer food storage package having a food storage container and an absorbent food pad to maintain a hygienic environment to preserve the freshness of food. A securing means may be used to hold the pad in position inside of the container. The container can be a rigid structure having a base or bottom, side walls that form an opening, and a preformed cover fitted to the opening that can be opened and closed to permit ingress and egress of food in the container. The container may also be a flexible plastic bag. The pad has an absorbent medium or superabsorbent medium and may contain an antimicrobial agent, an atmosphere modifying system, and any combinations thereof. The securing means may be rails, hooks or latches positioned inside the container on the bottom, side walls, or the underside of the cover. The securing means may be an integral part of the container, or may be permanently or removably attached to the container by an adhesive material. The securing means may also be an adhesive material on the absorbent food pad.

The present disclosure further provides a method for using the consumer food storage package to maintain a hygienic environment to preserve the freshness of food.

### BRIEF DESCRIPTION OF THE DRAWINGS

FIG. 1 is a perspective view of a consumer food storage package of the present disclosure.

FIG. 2 is a perspective view illustrating a securing device for the food storage container of FIG. 1.

FIG. 3 is another perspective view of a consumer food storage package of FIG. 1.

FIG. 4 is a bottom view of the removable cover of FIG. 1 with a securing device thereon.

FIG. 5 is a side view of the cover of FIG. 4.

FIG. 6 is a top view of an open food storage container of FIG. 1 with a securing device attached at the side walls.

FIG. 7 is a bottom view of the absorbent food pad of FIG. 1 with the pad having a securing means.

FIG. 8 is a perspective view of a flexible consumer food storage package of the present disclosure.

### DETAILED DESCRIPTION OF THE INVENTION

The present disclosure is a food storage package for consumers that maintains a hygienic environment to preserve the freshness of food, and to maintain a better quality of appearance, smell, and taste of food for a longer period of time than currently available.

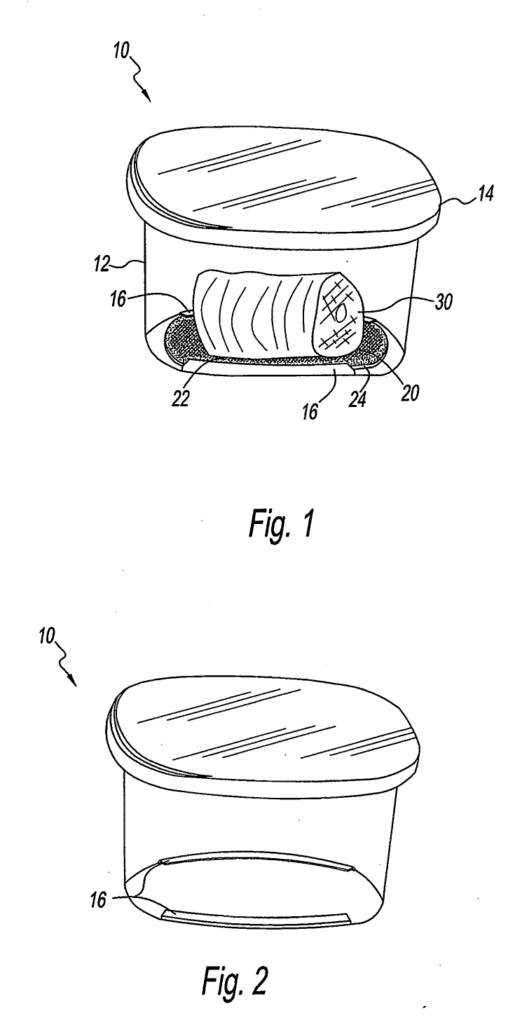

Referring to the drawings, and in particular, FIG. 1, there is provided a consumer food storage package of the present disclosure generally represented by the reference numeral 10. The package 10 has a food storage container 12. The container has a preformed, removable cover 14 that is fitted to the opening of container 12, and can be opened and closed onto container 12 to permit ingress and egress of food inside the container. The consumer food storage package 10 has an absorbent food pad 20. The pad 20 is disposable. The food storage package 10 may also have a securing device or means 16, such as a rail, hook, latch, or an adhering material, to hold pad 20 in place inside container 12, yet permit easy removal of pad 20 when the pad is ready for disposal. The consumer food storage package 10 may also have serving-size portions of food 30 placed within container 12.

The food storage container 12 is defined as an enclosed, sealed structure that completely encloses the stored food, and permits ingress and egress of the food by opening and closing a cover or portion of the container. An embodiment of the food storage container, as illustrated in FIGS. 1, 2 and 3, is a rigid structure having a base or bottom, side walls that form an opening, and a preformed cover 14 fitted to the opening that can be opened and closed multiple times onto container 12 to permit ingress and egress of food from the container without breaking the cover or the container. The container 12 is preferably of a size to be useful for refrigeration, freezing, or other storage of food, that is, large enough to completely enclose food 30 when removable cover 14 is placed onto container 12, yet small enough to fit within the desired type of refrigeration unit. As used herein, “refrigeration unit” includes any type of cooling device into which food may be placed, such as refrigerators, freezers, coolers and ice chests.

The securing means or device 16 can be any means that holds the absorbent food pad 20 in place inside container 12. The securing means 16 can be rails, hooks or latches attached inside container 12 to hold the absorbent food pad in position within the container. The securing means 16 permits easy removal of pad 20 when the pad is ready for disposal. In the embodiment illustrated in FIG. 1, the securing means 16 are two rails that hold the absorbent food pad 20 in place by overlapping a part of the edges of pad 20. The securing means 16 provides the benefit that the absorbent food pad is held in position within container 12 so that any shifting of food 30 within container 12 does not cause pad 20 to shift.

The securing means 16 may be made of plastic, rubber, polymers, composites, or any solid material. The securing means may be positioned anywhere inside the container, such as the bottom, side walls, or the underside of the cover of the container. There can be a plurality of securing means inside a food storage container 12.

The securing means 16 may be an integral part of container 12. Alternatively, the securing means may be permanently, or removably, attached to container 12 by an adhesive material. The adhesive material may be any adherent or bonding agent, such as glues, epoxies, or cements. The adhesive material preferably is water-resistant. Alternatively, the securing means can be part of the absorbent food pad 20. An example of such a securing means is a layer of adhesive on the bottom surface of pad 20.

FIG. 2 is an embodiment of the securing means 16 in which two rails are positioned along opposite sides of the bottom of container 12.

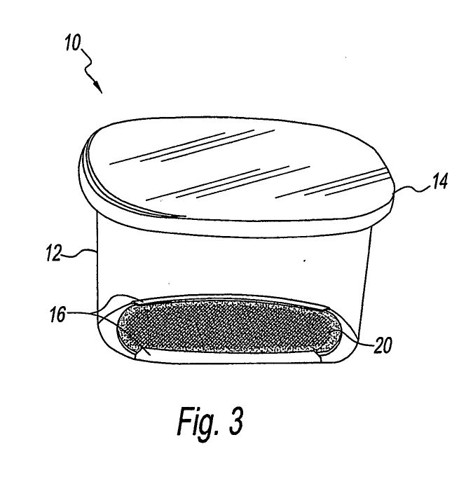

FIG. 3 illustrates a food storage container 12 that is a rigid structure with a preformed cover 14, securing means 16 that are two rails, and an absorbent food pad 20 held in position by the securing means 16.

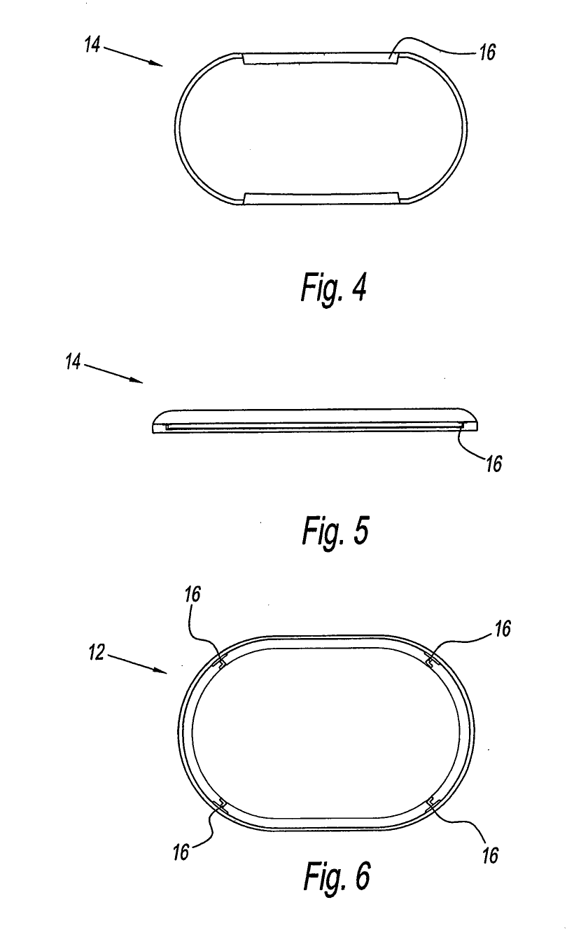

FIGS. 4 and 5 illustrate an embodiment of the present disclosure where securing means 16 is attached to the underside of the cover 14.

FIG. 6 is an embodiment of the present disclosure where the securing means 16 are positioned at the side walls of container 12. FIG. 6 illustrates securing means 16 having four separate rails, or two sets of rails, to secure two absorbent food pads 20 along the side walls of the container. Although FIGS. 4 to 6 illustrate embodiments having securing means in pairs or sets, the present disclosure also includes food storage packages 10 having a single securing means 16, as well as food storage packages 10 having two or more securing means. In FIG. 4, the securing means 16 as shown are two rails, but there could be in the embodiment, as well as the FIGS. 2 and 3 embodiments, more than two rails, or the two rails can be a discontinuous row of ridges with spaces therebetween.

The food storage container 12 having a rigid structure may be made of material such as plastic, plastic composites, rubber, aluminum, glass, stainless steel, PYREX™, or CORNINGWARE™. An example of a food storage container 12 having a rigid structure and preformed cover 14 is a TUPPERWARE™ container.

The absorbent food pads 20 of the present disclosure may also be shaped to fit the shape of the consumer food storage container 12. Examples of shapes of the absorbent food pads 20 include square, rectangular, circular, oval, oblong, polygon, trapezoid, triangle, donut-shaped, cone, rod, or any combinations thereof. U.S. patent application Ser. No. 10/802,254 discloses absorbent food pads of various shapes that can be used in the present disclosure, and is incorporated herein by reference. The absorbent food pad 20 may have a top sheet, a bottom sheet, and one or more islands disposed between the top sheet and the bottom sheet. The absorbent food pad may also have a base panel and one or more side panels hingeably connected to the base panel. Embodiments of the disclosure have one or more side panels that are foldable, allowing the pad 20 to conform to a base, side walls or underside of the cover of the food storage container 12.

“Absorbent food pad” as used herein would not include sachets or other packages that may contain active agents but cannot absorb large amounts of fluids exuded from food. The absorbent food pad 20 has an absorbent medium or superabsorbent medium. The absorbent medium or superabsorbent medium may be a material such as fluff pulp, cellulosic material, binding fiber, airlaid, nonwoven, woven, polymer, absorbent gels, superabsorbent polymer (SAP), compressed SAP composite of SAP granules adhered with one or more binders or plasticizers, airlaid with SAP, compressed composite with short or microfiber materials, thermoplastic polymer fibers, cellulose powders, and combinations thereof. The non-woven material may be spun-bonded polypropylene or perforated plastic film.

The absorbent food pads 20 may have a top surface that is a polymer film, including polyethylene or polypropylene that is manufactured or treated to have a coefficient of friction greater than 1.0. U.S. patent application Ser. No. 11/507,724 describes absorbent food pads having one or more non-slip surfaces that may be used in the present disclosure, is incorporated herein by reference. The absorbent medium or superabsorbent medium in the pad 20 is made of one or more materials that provide a nominal absorbency of about 5 parts per million (0.0005 wt %) to about 50,000 parts per million (5.0 wt %), where nominal absorbency is defined as the weight of the absorbed fluid exuded from the food that can be absorbed on the absorbent food pad. The nominal absorbency for the absorbent food pads used in embodiments of the disclosure are typically about 50 grams to 75 grams of fluid.

The absorbent food pads 20 may also contain active agents. Examples of active agents in pad 20 include one or more antimicrobial agent 22, one or more atmosphere modification system 24, and any combinations thereof. U.S. patent application Ser. No. 11/335,373, published as U.S. patent application Ser. No. 2006/0172048, describes absorbent food pads having active agents, and is incorporated herein by reference.

Antimicrobial agents 22 in the absorbent food pads 20 may be selected from the group consisting of one or more bacterial inhibitor, fungal inhibitor, viral inhibitor, disinfectant, sanitizer, sterilizer, mildewstat, surfactant, deodorizer, and any combinations thereof. Examples of antimicrobial agents 22 used in absorbent food pads 20 include a metal, metal compound, surfactant, organic acid, inorganic acid, quaternary ammonium salt, sulfite, biopolymer, synthetic polymer, chitin, chitosan, nisin, enzymatic system, antioxidant, and any combinations thereof.

Atmosphere modification systems 24 in the absorbent food pads 20 may be carbon dioxide (CO₂)-generating systems, oxygen (O₂)-scavenging systems, and any combinations thereof. One such CO₂-generating system that can be used in the present disclosure includes, but is not limited to, a system with an acid and base (such as citric acid and sodium bicarbonate), that, when reacted together, generate CO₂. Suitable O₂-scavenging systems that can be used in the present disclosure include, but are not limited to, metal oxidation reactions, enzyme catalyzed oxidation reactions, and any combinations thereof.

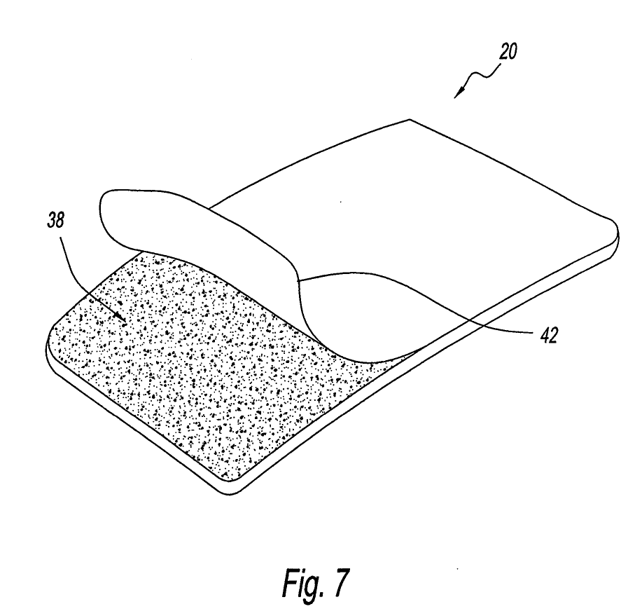

FIG. 7 illustrates a bottom view of an absorbent food pad 20 of the present disclosure, showing an embodiment where securing means 38 is on the pad 20 and comprises an adhesive material. Pad 20 has a covering sheet 42 that protects the adhesive and can be peeled off prior to placement in the container. After covering sheet 42 is peeled off, the adhesive material remains on the absorbent food pad 20. Pad 20 is then positioned on the inside of container 12, and pressed against the inside aspect of the container, so that the adhesive material removably bonds with an interior aspect of the food storage container. The adhesive material does not create a permanent bond, so that pad 20 may be removed and disposed after use. As used herein, the interior aspect of the container is the part of the food storage container 12 that is enclosed by the bottom, side walls, and cover of the container when the cover is placed thereon.

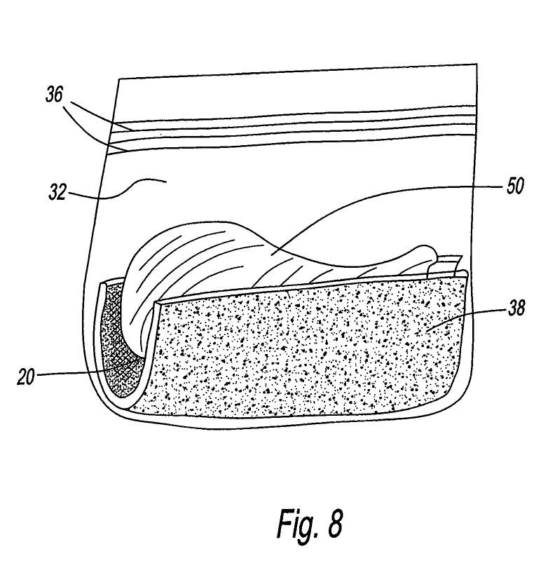

FIG. 8 illustrates another embodiment of the food storage package having a food storage container that is a flexible plastic bag 32. Bag 32 completely encloses food 50 when closed, and has an absorbent food pad 20 with a securing means or device 38. Bag 32 also has a sealing device, shown in FIG. 7 as sealing strips 36. In this embodiment, sealing strips 36 extend across part or all of the opening of the flexible plastic bag and can be opened and closed by the consumer to permit ingress and egress of food multiple times without breaking the food storage package. The absorbent food pad 20 may take the shape of the flexible plastic bag 32, or may be positioned anywhere on the interior aspect of flexible bag by securing means 38.

The present disclosure also provides a method of using the consumer food storage package to maintain a hygienic environment and to preserve the freshness of food. The method includes opening a consumer food storage container 12 having a base, side walls forming an opening, and a preformed cover 14 fitted to the opening; positioning an absorbent food pad 20 within the food storage container 12 by a securing means; placing food 30 inside of container 12; and closing container 12 by placing cover 14 onto the container. The cover 14 can be opened and closed multiple times to permit ingress and egress of food without breaking either the cover 14 or the container 12. Where the securing means is an adhesive material as part of the absorbent pad, the method further includes removing a covering sheet from the securing means before positioning the pad within the consumer food storage container.

The present method offers the benefit that when the consumer removes the food storage package from the refrigeration unit to be thawed, the moisture exuded from the food while thawing occurs activates the active agents in the absorbent food pad, such as antimicrobial agents and atmosphere modifying systems. This results in a burst of the activity of the active agents affecting the environment within the food storage container at a time that can be many days, weeks, or even months after the food was first placed inside the container. This delayed burst of activity of the active agents improves the safety and aesthetics of the food while thawing by reducing the colonization with microbes and development of poor appearance, color, or smell of the food.

Where the consumer food storage container is a flexible plastic bag 32 (as illustrated in FIG. 8), the method of preserving the freshness of food includes positioning an absorbent food pad 20 within the food storage container, placing food within the flexible plastic bag 32, and sealing the bag 32 by closing the sealing device 36. The consumer then places the bag 32 in a refrigeration unit for storage. When removed from the refrigeration unit, the moisture exuded by the thawing food 50 activates the active agents within the absorbent pad 20, resulting in a burst of activity of an antimicrobial agent and/or an atmosphere modifying system affecting the environment within the bag 32 that improves the safety and aesthetics of food 50 long after the consumer originally placed the food within the bag 32.

The present disclosure also provides a kit having a food storage package with: a food storage container; cover; absorbent food pad; securing means; and a moisture-resistant case to prevent contamination and prevent ambient moisture from being absorbed by the absorbent food pad before use.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the appended claims.

What is claimed is:

1. A consumer food storage package comprising:
a food storage container having a rigid structure with a bottom, side walls that form an opening, and a removable preformed cover fitted to the opening; and
an absorbent food pad having an absorbent or superabsorbent medium,
wherein the food storage container completely encloses the food when the cover is placed on the container, and wherein the cover can be opened and re-closed by the consumer to permit ingress and egress of food within the container without breaking the cover or the package.

2. The consumer food storage package according to claim 1, further comprising a securing means.

3. The consumer food storage package according to claim 2, wherein the securing means is positioned on an interior aspect of the container selected from the bottom, side walls, and underside of the cover of the container.

4. The consumer food storage package according to claim 3, wherein the securing means are one or more rails, hooks or latches that are an integral to the container.

5. The consumer food storage package according to claim 3, wherein the securing means are one or more rails, hooks or latches are removably or permanently attached to the container by an adhesive material.

6. The consumer food storage package according to claim 5, wherein the adhesive material is a bonding material, epoxy, or glue.

7. The consumer food storage package according to claim 2, wherein the securing means is on the absorbent food pad.

8. The consumer food storage package according to claim 7, wherein the securing means is an adhesive material on the surface of the absorbent food pad.

9. The consumer food storage package according to claim 8, wherein the securing means has a removable covering sheet.

10. The consumer food storage package according to claim 8, wherein the adhesive material removably bonds to an interior aspect of the container.

11. The consumer food storage package according to claim 1, wherein the absorbent food pad further comprises an antimicrobial agent, an atmosphere modifying system, or combination thereof.

12. The consumer food storage package according to claim 11, wherein the antimicrobial agent is selected from the group consisting essentially of a bacterial inhibitor, fungal inhibitor, viral inhibitor, disinfectant, sanitizer, sterilizer, mildewstat, surfactant, deodorizer, and any combinations thereof.

13. The consumer food storage package according to claim 11, wherein the atmosphere modifying system is selected from the group consisting of a CO₂-generating system, an oxygen-scavenging system, and any combinations thereof.

14. The consumer food storage package according to claim 1, wherein the absorbent food pad comprises one or more foldable side panels that conform to the shape of the base or walls of the food storage container.

15. A consumer food storage package comprising:
a flexible plastic food storage container;
an absorbent food pad having an absorbent medium or superabsorbent medium, an antimicrobial agent, an atmosphere modification system, and any combinations thereof; and
a securing means,
wherein the food storage container has a sealing device that can be opened and closed multiple times to permit ingress and egress of food without breaking the container, and wherein the container completely encloses the food when the sealing device is closed.

16. An absorbent food pad for use in a consumer food storage container comprising:
an absorbent or superabsorbent medium; and
a securing means.

17. The absorbent food pad according to claim 16, wherein the securing means comprises an adhesive material or high-friction material that is placed on the absorbent food pad.

18. The absorbent food pad according to claim 17, wherein the absorbent food pad further comprises a removable covering layer placed overtop the securing means.

19. A method of preserving the freshness of food inside a consumer food storage container, comprising:
opening a consumer food storage container having a rigid structure with a bottom, side walls that form an opening, and a preformed cover fitted to the opening;
positioning an absorbent food pad with a securing means within the container;
placing food within the container; and
closing the food storage container by placing the cover onto the container,
wherein the cover can be opened and closed multiple times to permit ingress and egress of food without breaking the cover or the container.

20. The method according to claim 19, further comprising:
cooling a consumer food storage package having a food storage container, absorbent food pad, securing means, and food in a refrigeration unit;
removing the consumer food storage package from the refrigeration unit;
thawing the food within the food storage package,
wherein moisture from thawing activates the antimicrobial agent, atmosphere modifying system, and any combinations thereof, in the absorbent food pad.
